(19) United States
(12) Patent Application Publication
(10) Pub. No.: US 2014/0259955 A1
(43) Pub. Date: Sep. 18, 2014

(54) ACCESS PORT FOR A SHRINK WINDOW KIT

(71) Applicants: Brian A. Vulpitta, Avon Lake, OH (US); Daniel Eric Festa, SR., Strongsville, OH (US); Vageesh Bakhshi, Brecksville, OH (US)

(72) Inventors: Brian A. Vulpitta, Avon Lake, OH (US); Daniel Eric Festa, SR., Strongsville, OH (US); Vageesh Bakhshi, Brecksville, OH (US)

(73) Assignee: SHURTECH BRANDS, LLC, Avon, OH (US)

(21) Appl. No.: 14/204,024

(22) Filed: Mar. 11, 2014

Related U.S. Application Data
(60) Provisional application No. 61/792,695, filed on Mar. 15, 2013.
(60) Provisional application No. 61/867,734, filed on Aug. 20, 2013.

(51) Int. Cl. E06B 7/28; E06B 7/02

(52) U.S. Cl. CPC E06B 7/28; E06B 7/02
USPC 49/502; 29/428

(57) ABSTRACT

An access port for a shrink film barrier that can be installed after installation of the shrink film barrier without removal of the shrink film barrier, and permits selective access to a window or door covered by the barrier.

This application claims priority to and the benefit of the filing date of U.S. Provisional Patent Application Ser. No. 61/792,695, filed Mar. 15, 2013, and U.S. Provisional Patent Application Ser. No. 61/867,734, filed Aug. 20, 2013, which applications are hereby incorporated by reference.

### BACKGROUND

The present exemplary embodiment relates to weather barriers for windows and doors. It finds particular application in conjunction with shrink film barriers, and will be described with particular reference thereto. However, it is to be appreciated that the present exemplary embodiment is also amenable to other like applications.

Shrink film weather barriers for windows and doors are known. Such barriers are often sold to homeowners in kits that allow a homeowner to cover several windows and/doors with film to insulate and/or reduce/eliminate drafts. Typically, once a barrier is installed it remains in place until it is no longer needed or desired at which time it is removed. In general, once a shrink film barrier is removed, it is no longer useful and it is discarded or recycled. An example of a shrink film weather barrier is disclosed in U.S. Pat. No. 5,937,596 issued on Aug. 17, 1999, which is hereby incorporated by reference herein in its entirety.

While the use of shrink film barriers can increase efficiency by stopping drafts from entering a home, there are times when the shrink film barriers can be inefficient. For example, if a warm spell occurs subsequent to a homeowner installing shrink film barriers on all the windows of his home, the homeowner may choose to operate the central air conditioner to cool the home rather than remove the shrink film barriers and open the windows. Because of this, some homeowners wait until any threat of a warm spell has passed, thereby foregoing any energy savings that might occur during earlier cold spells.

### BRIEF DESCRIPTION

Due to increased volatility in the weather, including earlier cold snaps and later warm spells in the fall, and earlier warm spells and later cold snaps in the spring, a need has been discovered for a shrink film barrier that provides selective access to an associated window, door etc. for opening and closing thereof, and/or for access to window coverings such as blinds or shades.

In accordance with an aspect of the present disclosure, an access port kit for creating a selectively openable port in an associated previously installed shrink film barrier comprises a closure mechanism securable to the associated shrink film barrier adjacent a cut in the shrink film barrier, said cut separating a flap portion from a remainder of the associated shrink film barrier, wherein the closure mechanism includes a first portion securable to the flap portion of the associated shrink film barrier, and a second portion securable to the remainder of the associated shrink film barrier, the first portion and the second portion adapted to selectively engage and disengage to thereby join and separate the flap portion and the remainder of the associated shrink film barrier.

The kit can further include adhesive and/or tape for securing at least one of the first or second portions of the closure member to the shrink film barrier. The closure mechanism can include a runner, said runner slideably secured to one of the first and second portions, and adapted to engage the first and second portions when slid in a first direction, and disengage the first and second portions when slid in a second direction. The closure mechanism can be adapted to form an airtight seal between the flap portion and the remaining portion of the shrink film barrier when the first and second portions are engaged.

In accordance with another aspect, a shrink film barrier comprises a film barrier having a movable flap, the movable flap being displaceable from a plane in which a remaining portion of the film barrier lies, and a closure mechanism attached to the film barrier for selectively securing the flap in a closed position. The closure mechanism includes a first portion secured to the movable flap and a second portion secured to the remainder of the film barrier, the first portion and the second portion adapted to selectively engage and disengage to thereby join and separate the flap portion and the remainder film barrier.

At least one of the first and second portions of the closure mechanism can be secured with adhesive and/or tape, or can be welded in place. The closure mechanism can include a runner, said runner slideably secured to one of the first and second portions, and adapted to engage the first and second portions when slid in a first direction, and disengage the first and second portions when slid in a second direction. The closure mechanism can be configured to form an airtight seal between the flap and the remaining portion of the film barrier when the first and second portions are engaged.

In accordance with another aspect, a method of installing an access port in a shrink film barrier covering a window opening of a dwelling comprises forming a flap in the barrier by cutting the film barrier, and securing a closure mechanism to the barrier, the closure mechanism adapted to selectively secure the flap in a closed position. The securing the closure mechanism includes securing a first portion to the flap and a second portion to the remainder of the film barrier, the first portion and the second portion adapted to selectively engage and disengage to thereby join and separate the flap and the remainder of the film barrier. The forming the flap in the barrier can be performed after the closure mechanism is secured to the barrier. The securing the closure mechanism can include using an adhesive, tape, and/or welding.

In accordance with another aspect, a method of installing an access port in a shrink film barrier covering an opening of a dwelling comprises forming an opening in the shrink film barrier, and placing a selectively removable material over at least a portion of the opening, whereby the selectively removable material closes the opening when installed and permits access to the opening when removed. The selectively removable material includes a static cling material attractive to the material of the film barrier. The forming the opening can include cutting the barrier film. The forming an opening can include slitting the film barrier material to form a flap in the film barrier that can be displaced from a plane of a remainder of the film barrier, and the placing the selectively removable material can include placing the selectively removable material on the flap portion and the remaining portion of the film barrier to thereby secure them together. The slitting can include making a u-shape slit.

### BRIEF DESCRIPTION OF THE DRAWINGS

FIG. 1 is an elevational view of an exemplary shrink film barrier installed on a window;

FIG. 2 is a shrink film barrier including a cut defining a flap portion;

FIG. 3 is the shrink film barrier of FIG. 2 with an exemplary closure installed thereon;

FIG. 4 is a closeup of the closure of FIG. 3;

FIG. 5 is another exemplary shrink film barrier;

FIG. 6 is yet another exemplary shrink film barrier;

FIG. 7 is a perspective view of an exemplary closure in a closed configuration in accordance with the present disclosure;

FIG. 8 is a perspective view of the closure of FIG. 7 in an open configuration; and

FIG. 9 is an elevational view of the closure of FIGS. 7 and 8 installed on a shrink film barrier of a window.

### DETAILED DESCRIPTION

FIG. 1 illustrates a window 10 having a shrink film barrier 12 installed thereon. The shrink film barrier 12 is secured peripherally to a frame 14 of the window. The shrink film 12 can be installed in any suitable fashion. Although shrink film is referred to in this disclosure, aspects of the disclosure are applicable to other types of films as well.

FIG. 2 illustrates the shrink film barrier 12 isolated from the window 10 for illustrative purposes. A U-shape cut is indicated by a dashed line generally identified by reference numeral 20. The cut 20 creates a flap portion 22 that can be manipulated to create an opening (access port) in the shrink film barrier 12. For example, the flap portion 22 of the barrier 12 can be pivoted out of the plane of the remainder of the barrier 12. Alternatively, the flap portion 22 can be rolled up, or otherwise displaced from the plane of the barrier 12. The opening allows access to the window for opening/closing etc. without requiring permanent removal of the barrier 12.

In FIG. 3, a closure 30 is shown installed on the barrier 12 for selectively closing/opening the cut 20. It will be appreciated that the flap portion 22 is shown in closed position such that the barrier 12 is substantially sealed to prevent airflow. The closure 30 generally comprises first and second closure components secured to the barrier on each side of the cut 20, and a closure mechanism for connecting/releasing the first and second closure components. An example of a suitable closure is a slide closure of the type often employed on freezer bags or the like. Such closures are similar to a zipper in that a sliding runner is used to join and separate a pair of flanges. Other closure types are also possible.

In FIG. 4, a first flange strip 40 including flange 42 is secured to the barrier 12 along the flap portion 22 adjacent the cut 20, while a second flange strip 44 including flange 46 is secured to the barrier 12 on the opposite side of the cut 20. A slider 44 slides along flanges 42 and 46 to join and separate the flanges. The inset in FIG. 4 illustrates the flanges 42 and 46 in a joined state. Reinforcing or strengthening members 50 are secured to the barrier 12 adjacent terminal ends of the cut 20. The strengthening members reinforce the shrink film to prevent or reduce the likelihood that the cut 20 will tear the film.

Turning to FIG. 5, another exemplary film barrier 50 is illustrated. In this embodiment, the film barrier 50 is similar to the film barrier 12 but instead of having a mechanical closure (e.g., slider 44), film barrier 50 includes an electrostatic cling closure generally indicated by reference numeral 54. The electrostatic cling closure 54 includes a first portion associated with a flap portion 58 and a second portion associated with the adjacent film barrier 50. That is, the overlapping region of the flap portion 58 and the film barrier 50 provides a cling force that retains the flap portion 58 in a closed position under a variety of circumstances, but permits separation for accessing the window when desired. For illustrative purposes, the film barrier 50 and flap portion 58 are crosshatched differently so as to clearly show the overlapping region. It should be appreciated, however, that the film barrier 50 and the flap portion 58 can be made of common or different materials.

Various configurations of film barrier 50 with a cling closure are contemplated, and FIG. 5 illustrates just one such configuration. In this embodiment, the film barrier 50 can generally be installed over a window or other opening in any desired manner, such as those mentioned above in connection with the embodiment of FIGS. 1-4. Once installed, flap portion 58 can be secured to the film barrier 50 with an adhesive, tape, or other method (plastic welding, etc.). In some embodiments, the flap portion can be provided already installed/secured on the film barrier 50 adjacent an opening therein, or the opening can be created before or after installation of the film barrier 50 on the window/door. In some embodiments, the flap portion can be a separate component secured to the film barrier along one or more edges thereof. It should also be appreciated that the flap portion 58 can be a separate sheet having cling properties that is placed over an opening in the film barrier 50.

Turning to FIG. 6, another exemplary embodiment is illustrated. In this embodiment, film barrier 70 is installed over a window or door (not shown), flap portion 72 is cut or otherwise separated from the remainder of the film barrier 70, and a separate cling strip 74 is placed along the cut to releasably secure the flap portion 72 with the remainder of the film barrier 70. The cling strip 74 extends across the cut/gap and secures the flap portion in a closed position. To open the flap portion, a user simply removes the cling strip 74 and displaces the flap portion as needed.

FIGS. 7 and 8 illustrate yet another exemplary closure 80. The closure 80 includes first and second flanges 82 and 84 that are joined/separated by a closure member in the form of a slider 86 (alternatively, the flanges can be joined by a press to close feature). It will be appreciated that the ends of the flanges 82 and 84 are crimped or otherwise permanently joined together such that the slider 86 is constrained therebetween. Each flange 82 and 84 has a corresponding flexible skirt 88 and 90, respectively, that is configured to be secured to a surface, such as a film barrier. In other embodiments, the skirts can be rigid or semi-rigid. Various conventional flange/slider constructions can be used without departing from the scope of this disclosure.

The closure 80 is configured to be secured to a film barrier 92 as shown in FIG. 9. In the illustrated embodiment, a strip of double-sided tape 94 is used to secure each of the flexible skirts 88 and 90 to the film barrier 92. Once secured, the closure 80 is opened, and a slit is cut in the barrier film 92 to provide access to the window or other structure upon which the film barrier 92 is secured.

Although the closure 80 is shown installed on the lower portion of the film barrier 92, it will be appreciated that it can be installed wherever desired by the end user. For example, the closure can be positioned to provide access to a window crank to allow opening and closing of the window. In another installation, the closure 80 can be placed adjacent a window shade mechanism for opening/closing a window shade. Other application of the closure will occur to an end user. In addition, multiple closures 80 can be installed on a single film barrier to provide access to more than one location as desired.

It will now be appreciated that the present disclosure sets forth an access port for a shrink film barrier that can be installed after installation of the shrink film barrier without removal of the shrink film barrier, and permits selective access to a window or door covered by the barrier.

In one embodiment, the access port can be installed by first making a cut in the film barrier to form a flap, and then installing a closure to allow selective closure of the flap. In another embodiment, the closure can first be installed on the film barrier, and then a cut can be made to form the flap with the closure serving as a template and/or guide for making the cut. In some embodiments, a single straight cut in the film is sufficient to create an opening for access (by deflecting the film surrounding the cut. Thus, the term flap is intended to encompass such installations. It will be appreciated that a closure and/or other elements described above can be secured to the film barrier in any suitable manner, such as with tape or adhesive, or welding or the like.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An access port kit for creating a selectively openable port in an associated previously installed shrink film barrier, the kit comprising:
a closure securable to the associated shrink film barrier adjacent a cut in the associated shrink film barrier;
wherein the closure includes a first portion securable to the associated shrink film barrier on a first side of the cut, and a second portion securable to the associated shrink film barrier on a second side of the cut, the first portion and the second portion adapted to selectively engage and disengage to thereby permit or restrict access to the cut in the associated shrink film barrier.

2. An access port kit as set forth in claim 1, further comprising adhesive for securing at least one of the first or second portions of the closure to the associated shrink film barrier.

3. An access port kit as set forth in claim 1, wherein the closure includes a runner, said runner slideably secured to flanges of at least one of the first and second portions, and adapted to engage the first and second portions when slid in a first direction, and disengage the first and second portions when slid in a second direction.

4. An access port kit as set forth in claim 1, further comprising tape for securing the first and second portions of the closure to the associated shrink film barrier.

5. An access port kit as set forth in claim 1, wherein the closure forms an airtight seal when the first and second portions are engaged.

6. A shrink film barrier comprising:
a film barrier having a movable flap, the movable flap being displaceable from a plane in which a remaining portion of the film barrier lies; and
a closure mechanism attached to the film barrier for selectively securing the flap in a closed position;
wherein the closure mechanism includes a first portion secured to the movable flap and a second portion secured to the remainder of the film barrier, the first portion and the second portion adapted to selectively engage and disengage to thereby join and separate the flap portion and the remainder film barrier.

7. A shrink film barrier as set forth in claim 6, wherein at least one of the first and second portions of the closure mechanism is secured with adhesive.

8. A shrink film barrier as set forth in claim 6, wherein the closure mechanism includes a runner, said runner slideably secured to one of the first and second portions, and adapted to engage the first and second portions when slid in a first direction, and disengage the first and second portions when slid in a second direction.

9. A shrink film barrier as set forth in claim 6, wherein at least one of the first and second portions of the closure mechanism is secured with tape.

10. A shrink film barrier as set forth in claim 6, wherein the closure mechanism forms an airtight seal between the flap and the remaining portion of the film barrier when the first and second portions are engaged.

11. A method of installing an access port in a shrink film barrier
covering a window opening of a dwelling, the method comprising:
forming a flap in the barrier by cutting the film barrier; and
securing a closure mechanism to the barrier, the closure mechanism adapted to selectively secure the flap in a closed position;
wherein the securing the closure mechanism includes securing a first portion to the flap and a second portion to the remainder of the film barrier, the first portion and the second portion adapted to selectively engage and disengage to thereby join and separate the flap and the remainder of the film barrier.

12. A method as set forth in claim 11, wherein the forming the flap in the barrier is performed after the closure mechanism is secured to the barrier.

13. A method as set forth in claim 11, wherein the securing the closure mechanism includes using an adhesive.

14. A method as set forth in claim 13, further comprising using tape.

15. A method as set forth in claim 12, wherein the securing includes welding.

16. A method of installing an access port in a shrink film barrier covering an opening of a dwelling comprising:
forming an opening in the shrink film barrier;
placing a selectively removable material over at least a portion of the opening;
whereby the selectively removable material closes the opening when installed and permits access to the opening when removed.

17. A method as set forth in claim 16, wherein the selectively removable material includes a static cling material.

18. A method as set forth in claim 16, wherein the forming the opening includes cutting the barrier film.

19. A method as set forth in claim 16, wherein the forming an opening includes slitting the barrier material to form a flap in the barrier film that can be displaced from a plane of a remainder of the film barrier, and the placing the selectively removable material includes placing the selectively removable material on the flap portion and the remaining portion of the film barrier to thereby secure together.

20. A method as set forth in claim 19, wherein the slitting includes making a u-shape slit.

21. A method of installing an access port in a shrink film barrier covering a window opening of a dwelling, the method comprising:
securing a closure to the shrink film barrier, the closure including a first portion securable to the shrink film barrier and a second portion securable to the shrink film barrier in spaced relation to the first portion, the first and second portions defining therebetween an access port location, the first and second portions adapted to selectively engage and disengage to thereby permit or restrict access to the access port location; and
cutting the shrink film barrier in the region of the access port location to create an opening in the shrink film barrier;
whereby selective access to the opening in the shrink film barrier is made by engaging and disengaging the first and second portions of the closure.

22. The method of claim 21, wherein the securing the closure includes using a strip of double-sided tape.
